(19) United States
(12) Patent Application Publication
(10) Pub. No.: US 2015/0289544 A1
(43) Pub. Date: Oct. 15, 2015

(54) SOUS VIDE COOKING

(71) Applicant: FNV Labs Ltd., Woking (GB)

(72) Inventors: José Guilherme Mendonça Vilela Pinto Ferreira, Lisbon (PT); Ana Catarina Violante Vieira, Obidos (PT)

(21) Appl. No.: 14/248,476

(22) Filed: Apr. 9, 2014

(51) Int. Cl. A23L 1/01; G06F 17/30

(52) U.S. Cl. CPC A23L 1/0121; G06F 17/30386; A23V 2002/00

(57) ABSTRACT

A method for “sous-vide” cooking includes receiving food type, food quantity, cook begin time, and cook finish time parameters and looking up a default time-temperature pair in a cooking services database. When the default time-temperature pair is suitable for yielding a cooked food meeting the food type, food quantity, cook begin time, and cook finish time parameters, a cooking control routine is derived from the default time-temperature pair. Subsequently, a cooking process may be performed in accordance with the cooking control routine.

### TECHNICAL FIELD

The present disclosure relates generally to cooking and, more particularly, to “sous-vide” cooking as well as methods, processes and procedures related thereto.

### BACKGROUND

Cooking and enjoying food are popular pastimes. In both domestic and professional settings, “sous-vide” cooking is becoming increasingly common. In “sous-vide” cooking, food is cooked for relatively longer times at relatively lower temperatures, and is generally separated from a cooking medium by packaging in airtight plastic bags. The cooking medium is usually a temperature-controlled water bath or steam oven which allows for rapid heat transfer between the packaged food and the cooking medium.

In general, “sous-vide” cooking requires that cooking temperatures and durations be controlled precisely to obtain a desired end result, namely, a palatable cooked food that is safe from food-borne bacteria. A user might want to use a non-standard time and temperature combination, for example, to accommodate a set schedule or a lack of time. Moreover, the user might want to modify a well-known time and temperature combination to make an affordance for his or her personal taste. However, deviating from well-known time and temperature combinations can result in food that is not safe or palatable. As a result, conventional methods for “sous-vide” cooking are prone to delays and errors and may cause fears over food safety.

For illustration purposes, in an example situation where a user wishes to cook steak “sous-vide” for his or her dinner, the user may refer to a recipe book or search online for a “sous-vide” recipe. The “sous-vide” recipe may specify, for example, that steak be cooked for approximately two to three hours at 57 degrees Centigrade (57° C.). If the user has only one hour, her or she may wish to adjust the “sous-vide” recipe as per his or her current requirement.

Traditionally, the user has had two options. As a first option, the user may have chosen to delay his or her steak dinner. As a second option, the user may have chosen to arbitrarily modify the “sous-vide” recipe ad hoc, for example, to one hour at 59 degrees Centigrade (59° C.). The first option is inconvenient to the user and the second option risks the cooked steak being unpalatable, unsafe or both.

### SUMMARY

In one aspect, a method for “sous-vide” cooking is disclosed. Various cooking parameters including one or more of: food type, food quantity, degree of cook, cook begin time, and cook finish time parameters are received. A default time-temperature pair is looked up in a cooking services database.

When the default time-temperature pair is suitable for yielding a cooked food meeting the food type, food quantity, cook begin time, and cook finish time parameters, a cooking control routine is derived from the default time-temperature pair and a cooking process is performed in accordance with the cooking control routine.

In another aspect, a method for food treatment is disclosed. Various cooking parameters including one or more of: food type, food quantity, degree of cook, cook begin time, and cook finish time parameters are received from a client interface. The food type and food quantity parameters are employed to look up the default time-temperature correlated to the food type and food quantity parameters in a cooking services database.

When the default time-temperature pair is not capable of yielding a cooked food meeting the food type, food quantity, cook begin time and cook finish time parameters, a new time-temperature pair is produced. When the new time-temperature pair is capable of yielding a cooked food meeting the various cooking parameters, a cooking control routine is derived from the new time-temperature pair.

The cooking control routine is transmitted to a cooking control module of the cooking device. Thereafter, a cooking process is performed in accordance with the cooking control routine.

### DESCRIPTION OF THE DRAWINGS

The disclosure is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those having skill in the art will understand that the drawings are not to scale. Wherever possible, like elements have been indicated by identical numbers.

Embodiments of the present disclosure will now be described, by way of example only, with reference to the following diagrams wherein:

FIG. 1 illustrates a schematic of a cooking system suitable for implementing a method for “sous-vide” cooking, in accordance with embodiments of the present disclosure;

FIGS. 2A, 2B and 2C collectively illustrate example steps of a method for “sous-vide” cooking, in accordance with an embodiment of the present disclosure; and

FIGS. 3A, 3B and 3C collectively illustrate example steps of a method for food treatment, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION

Embodiments of the present disclosure substantially eliminate or at least partially address problems in the prior art; and facilitate personalization of a time-temperature pair for easy and safe “sous-vide” cooking of food.

Additional aspects, advantages, features and objects of the present disclosure would be made apparent from the drawings and the detailed description of the illustrative embodiments construed in conjunction with the appended claims.

The following detailed description illustrates embodiments of the present disclosure and ways in which they can be implemented. Although the best mode of carrying out the present embodiments has been disclosed, those skilled in the art will recognize that other embodiments for carrying out or practicing the present disclosure are also possible. It will be appreciated that features of the present disclosure are susceptible to being combined in various arrangements without departing from the scope of the present disclosure as defined by the appended claims.

It should be noted that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced item.

A method for “sous-vide” cooking includes receiving various cooking parameters including one or more of: food type, food quantity, degree of cook, cook begin time, and cook finish time parameter. One or more of the various cooking parameters may be received from a client interface or from a cooking device. In an example, the food quantity parameter is measured by a scale of the cooking device.

The food type and food quantity parameters are employed to look up a default time-temperature pair correlated to the food type and food quantity parameters in the cooking services database.

Subsequently, it is determined whether the default time-temperature pair is suitable to yield a cooked food meeting the food type, food quantity, cook begin time and cook finish time parameters. In other words, it is determined whether the default time-temperature pair is capable of yielding a cooked food meeting the food type, food quantity, cook begin time and cook finish time parameters.

If the default time-temperature pair is suitable for yielding a cooked food meeting the food type, food quantity, cook begin time, and cook finish time parameters, a cooking control routine is derived from the default time-temperature pair. This default time-temperature pair may be provided to a client interface.

If the default time-temperature pair is not suitable, a new time-temperature pair is produced (hereinafter referred to as a producing action). In order to produce the new time-temperature pair, the default time-temperature pair may be adjusted in accordance with the food quantity parameter. Furthermore, the default time-temperature pair may be adjusted in accordance with cooking device parameters of the cooking device.

Moreover, the producing action may include applying an adaptation rule from the cooking services database. In an example, the adaptation rule may be influenced by a heat equation approximation for the food type and food quantity parameters. In another example, the adaptation rule may be influenced by pathogen decay curves.

An assessment is made as to whether the new time-temperature pair represents an unacceptable deviation from one or more time-temperature pairs known to yield a palatable and safely cooked food (hereinafter referred to as an assessing action). In an example, the producing and assessing actions may be iteratively executed while the new time-temperature pair represents an unacceptable deviation from the one or more time-temperature pairs known to yield a palatable and safely cooked food.

If the iterative execution of the producing and assessing actions fails to establish an acceptable new time-temperature pair, the iterative execution may conclude after a number of iterations equal to a predetermined limit number. When iterative execution concludes in this way, a notification may be provided to the client interface reflecting a failure to establish a new time-temperature pair that is acceptable.

In an example, the food type and food quantity parameters are employed to select a maximum palatable temperature from the cooking services database. In another example, it may be determined whether the new time-temperature pair necessitates exceeding the maximum palatable temperature. When the new time-temperature pair necessitates exceeding the maximum palatable temperature, the producing action may be repeated.

Also, the producing action may be repeated when the new time-temperature pair is determined to be incapable of yielding a cooked food meeting the degree of cook parameter.

Finally, when the new time-temperature pair is determined to be capable of yielding a cooked food meeting the various cooking parameters, the cooking control routine is derived from the new time-temperature pair. This cooking control routine as well as the new time-temperature pair may be provided to a client interface.

The cooking control routine may also be transmitted to a cooking control module of the cooking device. The cooking control module is arranged to regulate conditions of a cooking chamber of the cooking device, including but not limited to refrigeration, cooking, and circulation of the cooking chamber as well as combinations of these.

A cooking process may then be performed in accordance with the cooking control routine. During the cooking process, the cooking control module may activate a cooling module or a heating module of the cooking device to decrease or increase temperature of the cooking chamber in accordance with the cooking control routine. The cooking control module may also control agitation and/or circulation of a cooking medium filled in the cooking chamber in accordance with the cooking control routine.

In an example, cooking feedback may be received from the client interface. The default time-temperature pair may then be modified in accordance with the cooking feedback, and updated in the cooking services database.

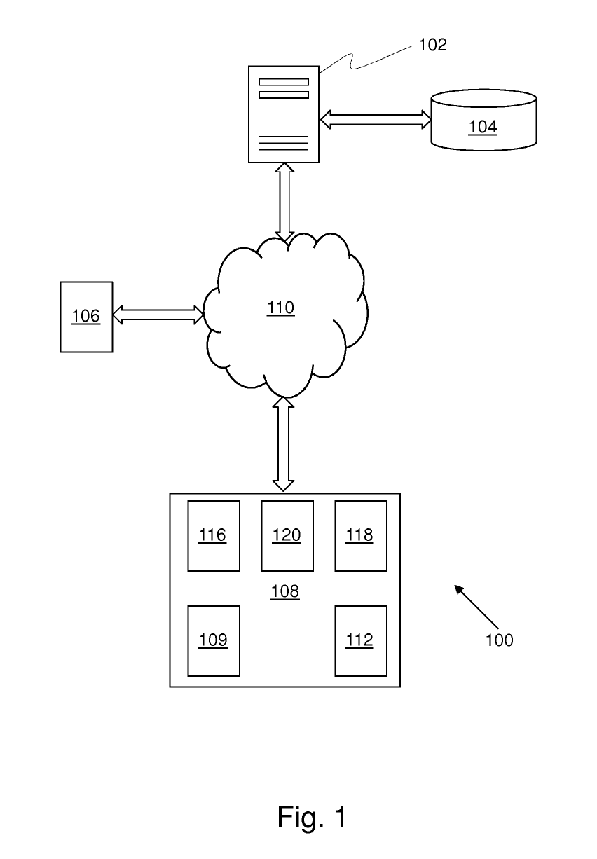

Referring now to the drawings, particularly by their reference numbers, FIG. 1 illustrates a schematic of a cooking system 100 suitable for implementing a method for “sous-vide” cooking, in accordance with embodiments of the present disclosure. Cooking system 100 includes a server 102, a cooking services database 104, a user device 106, and a cooking device 108. FIG. 1 shows one cooking device and one user device for illustration purposes only. It is to be noted here that the cooking system 100 can be implemented with any number of cooking devices and user devices.

The cooking system 100 may be implemented in various ways, depending on various possible scenarios. In one example, the cooking system 100 may be implemented by way of a spatially collocated arrangement of the server 102 and the cooking services database 104, as shown in FIG. 1. In another example, the cooking system 100 may be implemented by way of a spatially distributed arrangement of the server 102 and the cooking services database 104 coupled mutually in communication via a communication network. In yet another example, the server 102 and the cooking services database 104 may be implemented via cloud-based computing services.

The server 102 is operatively coupled to the user device 106 and the cooking device 108, via a communication network 110.

The communication network 110 can be a collection of individual networks, interconnected with each other and functioning as a single large network. Such individual networks may be wired, wireless, or a combination thereof. Examples of such individual networks include, but are not limited to, Local Area Networks (LANs), Wide Area Networks (WANs), Metropolitan Area Networks (MANs), Wireless LANs (WLANs), Wireless WANs (WWANs), Wireless MANs (WMANs), the Internet, second generation (2G) telecommunication networks, third generation (3G) telecommunication networks, fourth generation (4G) telecommunication networks, satellite-based telecommunication networks, and Worldwide Interoperability for Microwave Access (WiMAX) networks.

Moreover, the cooking device 108 includes a cooking control module 112. A network interface 114 is coupled with the cooking control module 112 and is configured for communication through the communication network 110.

In order to control cooking device 108 and/or access various services provided by the server 102, user device 106 may employ software or a computer program product that provides a remote client interface to a user of the cooking device 108. The computer program product may be a native application, an application running on a browser, or a plug-in application provided by a website, such as a social networking website. Optionally, the remote client interface may be implemented by way of an interactive Graphical User Interface (GUI).

User device 106 may be implemented using a computing device including computing hardware operable to execute the aforementioned program product. Examples of such computing devices include, but are not limited to, mobile phones, smart telephones, Mobile Internet Devices (MIDs), tablet computers, Ultra-Mobile Personal Computers (UMPCs), phablet computers, Personal Digital Assistants (PDAs), web pads, Personal Computers (PCs), handheld PCs, laptop computers, desktop computers, large-sized touch screens with embedded PCs, and other interactive devices, such as Television (TV) sets and Set-Top Boxes (STBs).

Moreover, the server 102 may be formulated to provide cooking services, through the communication network 110 and the network interface 114, to the cooking control module 112 and the remote client interface.

The cooking services database 104 may be configured to provide, to the server 102, a variety of information and instructions employable to set a cooking chamber circulation and temperature using the cooking control module 112. The cooking services database 104 may be configured to store past actions and preferences of the user that may be indicative of a personal taste of that user.

Moreover, the cooking services database 104 may additionally store one or more cooking device parameters of the cooking device 108, for example, thermal characteristics of the cooking device 108. These thermal characteristics may include at least one of:

(i) a minimum temperature that can be set, namely, a minimum refrigeration temperature;
(ii) a maximum temperature that can be set, namely, a maximum cooking temperature; and/or
(iii) a heat capacity of the cooking device 108.

In an example, the server 102 may receive cooking device parameters from the cooking device 108. In this regard, the maximum and minimum temperatures and the heat capacity of the cooking device 108 may be established by default from, for example, its make, model number, serial number or a combination of these. Additionally or alternatively, the server 102 may be operable to estimate the heat capacity of the cooking device 108 from an analysis of past records of time taken to heat up or cool down a cooking chamber of the cooking device 108. With the ability to store one or more cooking device parameters, system 100 is usable with a variety of cooking devices.

Moreover, the cooking services database 104 optionally stores time-temperature pairs known to yield palatable and safely cooked food of various types. These time-temperature pairs may be predetermined and aggregated by the server 102, for example, based on past experiences and preferences of various users.

Furthermore, the cooking device 108 includes a cooling module 116 for decreasing temperature of the cooking chamber of the cooking device 108, and a heating module 118 for increasing temperature of the cooking chamber. The cooking device 108 may further include a scale 120 for measuring a quantity of food.

In an illustrative example, the cooking device 108 is installed at a residence of a user. When the user places a cooking subject, namely, food to be cooked, into a flexible vessel and places the flexible vessel inside the cooking chamber of the cooking device 108, the cooking control module 112 may be operable to send a signal to the server 102 based on a change in mass detected by a scale 120 of the cooking device 108. The server 102 may be operable to then provide a notification to the remote client interface of the user device 106, for example, to ask the user whether he or she wishes to implement a cooking process.

If the user confirms that he or she wishes to cook, the server 102 may be operable to request that the user provide one or more cooking parameters. These cooking parameters may, for example, include one or more of: food type, food quantity, degree of cook, cook begin time, and/or cook finish time parameters. However, cooking parameters usable with disclosed methods are not limited to these.

The food type parameter may correspond to a type of food to be cooked, for example, such as vegetables, fruits, seafood, fish, poultry, or meat. The food type parameter may include more detailed or more specific information about the type of food to be cooked. Some examples of the food type include, but are not limited to, beef short ribs, fillet steak, asparagus, chicken, egg and so on. Additionally, the food type parameter may include information regarding the provenance of the cooking subject, for example, fresh, frozen, organic, raw, canned and so on.

The food quantity parameter optionally corresponds to a quantity of food to be cooked, namely, a mass, weight and/or size of the cooking subject. In an example, the food quantity parameter specifies a thickness of the cooking subject and/or a number of portions of the cooking subject. In some examples, the food quantity parameter may be measured by the scale 120 of the cooking device 108, and provided to the server 102.

The degree of cook parameter may correspond to an extent or doneness to which the user wishes the cooking subject to be cooked. In an example, the extent or doneness to which the user wishes a piece of meat be cooked may include gradations, such as medium rare, medium, medium well, well done and so on.

The cook begin time parameter may correspond to a time and/or date when the user wishes a cooking process to be started, while the cook finish time parameter may correspond to a time and/or date by when he/she wishes the cooking process to be finished.

In an example, when the user specifies that the cooked food be ready in two hours, the server 102 takes a current time as a cook begin time, and establishes two hours from the current time as a cook finish time. In another example, when the user specifies that the cooked food be ready in two hours by 8 PM, the server 102 takes 8 PM as the cook finish time, and derives a cook begin time of 6 PM from the 2 hour duration and 8 PM finish time.

It is to be noted here that the cooking system 100 is operable to allow the user to provide the cooking parameters remotely via the remote client interface, for example, when he or she is far away from his or her residence.

In some examples, the cooking parameters may be provided by selecting from a plurality of pre-set cooking recipes and/or previous cooking preferences.

Moreover, in some examples, the cooking system 100 may be operable to allow the user to provide the cooking parameters in a natural language. For example, the server 102 may be operable to interpret the cooking parameters using natural language processing techniques.

In an example, the user may provide “fillet steak, medium rare, ready at dinner time” as an input for the cooking parameters. In this example, the type of food is fillet steak, the degree of cook is medium rare, and the cook finish time is a default dinner time which may have been previously set by the user as default. In this example, the food quantity can be measured by the scale 120 of the cooking device 108.

It is to be noted here that the cook begin time need not necessarily be provided. In the above example, the cook begin time is not provided, and therefore, there is no limit to a duration for which the cooking subject is to be cooked. Accordingly, any suitable time-temperature pair can be produced for the provided cooking parameters.

In another implementation of the cooking system 100, the cooking device 108 includes a local client interface allowing the user to provide the cooking parameters locally from the cooking device 108. Thus, throughout the present disclosure, the term “client interface” may refer to the remote client interface of the user device 106 or the local client interface of the cooking device 108.

Upon receiving cooking parameters from the client interface, the server 102 is operable to look up or retrieve a default time-temperature pair from the cooking services database 104. For this purpose, the server 102 may employ the food type and food quantity parameters to look up a default time-temperature pair correlated to the food type and food quantity parameters.

The server 102 is operable to then determine whether the default time-temperature pair is suitable for yielding a cooked food meeting one or more of the various cooking parameters. The server 102 is operable to derive a cooking control routine from the default time-temperature pair, when the default time-temperature pair is suitable. Additionally, the server 102 may be operable to provide the default time-temperature pair to the client interface.

Otherwise, when the default time-temperature pair is not suitable, the server 102 is operable to produce a new time-temperature pair. In order to produce the new time-temperature pair, the server 102 may be operable to adjust the default time-temperature pair in accordance with the food quantity parameter. Additionally, the server 102 may adjust the default time-temperature pair in accordance with the cooking device parameters.

Moreover, the server 102 may be operable to apply an adaptation rule to the default time-temperature pair, in order to produce the new time-temperature pair. For this purpose, the server 102 fetches the adaptation rule from the cooking services database 104. In some examples, the adaptation rule may be influenced by a heat equation approximation for the food type and food quantity parameters. This may ensure that an inner core of the cooking subject is cooked at a suitable temperature, so as to yield a palatable cooked food that conforms to the degree of cook parameter.

Additionally, the adaptation rule may be influenced by pathogen decay curves. This may ensure that the cooking process yields a safely cooked food that is free from food-borne pathogens.

Moreover, the server 102 may be operable to assess whether the new time-temperature pair represents an unacceptable deviation from one or more time-temperature pairs known to yield a palatable and safely cooked food. For this purpose, the server 102 may fetch the one or more time-temperature pairs from the cooking services database 104.

The server 102 is operable to iteratively execute the producing and assessing actions, while the new time-temperature pair represents an unacceptable deviation from the one or more time-temperature pairs known to yield a palatable and safely cooked food.

When the server 102 fails to establish a new time-temperature pair that is acceptable, the server 102 may be operable to conclude the iterative execution after a number of iterations equal to a predetermined limit number. Additionally, the server 102 may provide a notification to the client interface reflecting a failure to establish an acceptable new time-temperature pair.

Additionally or alternatively, the server 102 may be operable to employ the food type and food quantity parameters to select a maximum palatable temperature from the cooking services database 104. Subsequently, the server 102 may determine whether the new time-temperature pair necessitates exceeding the maximum palatable temperature. When the new time-temperature pair necessitates exceeding the maximum palatable temperature, the server 102 may repeat the producing action.

Additionally, the server 102 may be operable to repeat the producing action when the new time-temperature pair is determined to be incapable of yielding a cooked food meeting the degree of cook parameter.

Finally, when the new time-temperature pair is determined to be capable of yielding a cooked food meeting the various cooking parameters, the server 102 is operable to derive the cooking control routine from the new time-temperature pair. Additionally, the server 102 may provide the new time-temperature pair to the client interface.

Subsequently, the server 102 may transmit the cooking control routine to the cooking control module 112 of the cooking device 108.

Upon receiving the cooking control routine, the cooking device 108 is operable to perform the cooking process in accordance with the cooking control routine. For this purpose, the cooking control module 112 is arranged to regulate conditions of the cooking chamber, namely, refrigeration and/or cooking and/or circulation conditions of the cooking chamber.

During the cooking process, the cooking control module 112 may activate the cooling module 116 or the heating module 118 of the cooking device 108 to decrease or increase temperature of the cooking chamber in accordance with the cooking control routine. Additionally, the cooking control module 112 may be operable to control agitation and/or circulation of a cooking medium filled in the cooking chamber in accordance with the cooking control routine.

Furthermore, the server 102 may be operable to receive cooking feedback from a client interface. The server 102 may then modify the default time-temperature pair in accordance with the cooking feedback, and update the modified default time-temperature pair in the cooking services database 104. Alternatively, the server 102 may store the new time-temperature pair as a separate default time-temperature pair in the cooking services database 104.

In this manner, the cooking system 100 is operable to allow the user to remotely control the cooking device 108 for cooking food, and to provide the user with new time-temperature pairs when default time-temperature pairs are not suitable.

FIG. 1 is merely an example, which should not unduly limit the scope of the claims herein. It is to be understood that the specific designation for the cooking system 100 is provided as an example and is not to be construed as limiting the cooking system 100 to specific numbers, types, or arrangements of servers, cooking services databases, user devices, and cooking devices. A person skilled in the art will recognize many variations, alternatives, and modifications of embodiments of the present disclosure.

In an illustrative example, a default time-temperature pair, fetched by the server 102 from the cooking services database 104, specifies that a cooking subject be cooked for approximately two to three hours at 57 degrees Centigrade (57° C.). As per the default time-temperature pair, the cooking process should begin at least two hours before a cook finish time desired by the user. In this example situation, the user has only one hour and wishes to adjust the default time-temperature pair as per the time available to him or her.

The server 102 analyzes various cooking parameters, including the cook begin time and cook finish time parameters, to produce a new time-temperature pair, as described earlier. The server 102 applies the adaptation rule to ensure that the new time-temperature pair is capable of yielding a palatable and safely cooked food meeting the various cooking parameters.

Accordingly, the new time-temperature pair so produced specifies that the cooking subject be cooked for one hour at 63 degrees Centigrade (63° C.).

Later, the server 102 may receive cooking feedback from the user regarding how well-suited to his or her taste the cooking subject was cooked. The server 102 then either modifies the default time-temperature pair or stores the new time-temperature pair separately in the cooking services database 104.

In the above example, if the user placed the cooking subject inside the cooking chamber at approximately 8 AM, and specified that the cooking process begin at 7 PM and finish at 8 PM, the cooking control module 112 activates the cooling module 116 of the cooking device 108 to cool down the cooking chamber to a desired refrigeration temperature until cooking is scheduled to begin. This enables the cooking device 108 to keep the cooking subject inside the cooking chamber safe for consumption for a same duration as a conventional refrigerator.

The desired refrigeration temperature may, for example, range from zero degrees Centigrade (0° C.) to seven degrees Centigrade (7° C.) and, more particularly, from two degrees Centigrade (2° C.) to five degrees Centigrade (5° C.). The desired refrigeration temperature may be either user-defined or system-defined by default. In an example, the cooking system 100 may allow the user to define the desired refrigeration temperature, for example, via the remote client interface of the user device 106 or the local client interface of the cooking device 108. The cooking services database 104 may store the desired refrigeration temperature for the cooking device 108. Additionally or alternatively, the cooking control module 112 stores the desired refrigeration temperature locally.

Furthermore, the cooking control module 112 regulates the cooling module 116 to maintain the cooking chamber at the desired refrigeration temperature, as per the cooking control routine. The cooking control module 112 then deactivates the cooling module 116 and activates the heating module 118 to heat the cooking chamber to a desired cooking temperature slightly before 7 PM, for example, depending on the heat capacity of the cooking device 108.

The cooking control module 112 then regulates the heating module 118 to maintain the cooking chamber at the desired cooking temperature for the desired duration, namely, at 63 degrees Centigrade (63° C.) for one hour. As a result, the cooking process is finished by 8 PM, as the user desired.

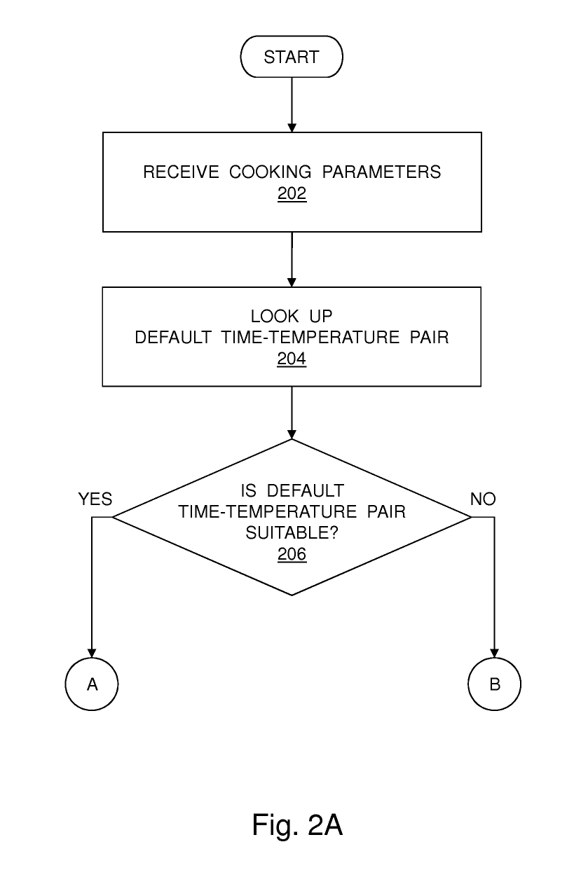

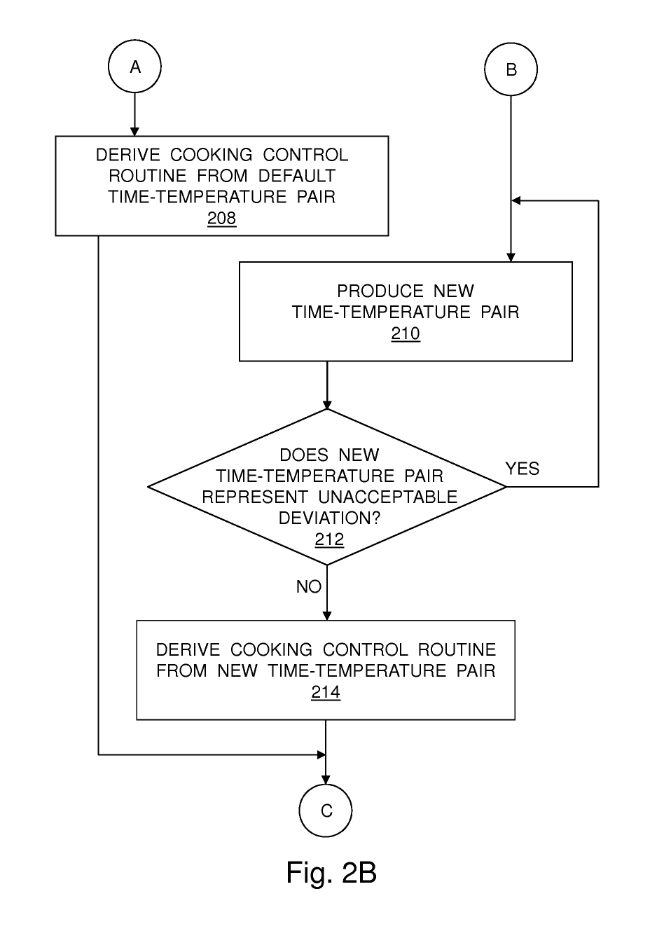

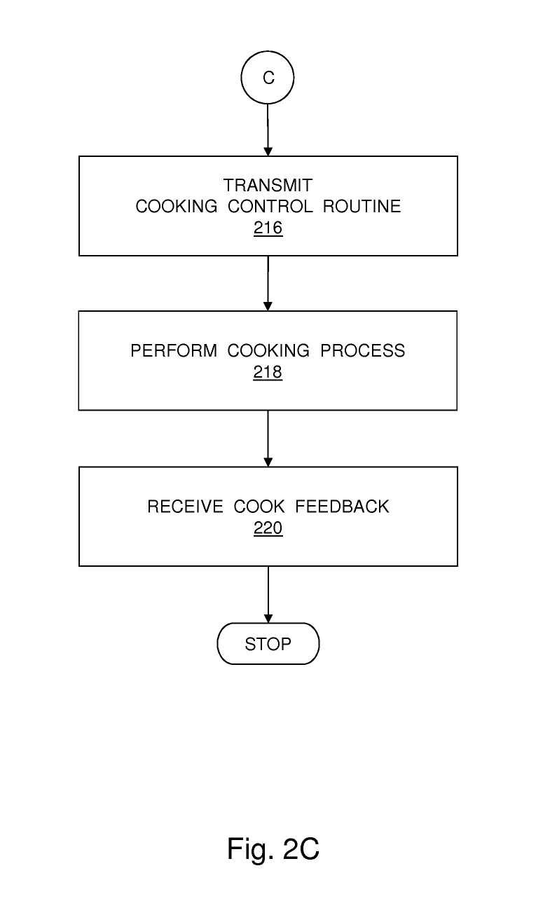

FIGS. 2A, 2B and 2C collectively illustrate steps of a method for “sous-vide” cooking, in accordance with an embodiment of the present disclosure. The method is depicted as a collection of steps in a logical flow diagram, which represents a sequence of steps that can be implemented in hardware, software, or a combination thereof.

By way of example only, the method has been illustrated with reference to the cooking system 100 as described in conjunction with FIG. 1.

In accordance with a step 202, the server 102 receives various cooking parameters including one or more of: food type, food quantity, degree of cook, cook begin time, and cook finish time parameters. In one example, the server 102 receives one or more of the various cooking parameters from the remote client interface of the user device 106 while, in another example, the server 102 receives one or more of the various cooking parameters from the cooking device 108. For example, the food quantity parameter may be received as measured by the scale 120 of the cooking device 108.

At a step 204, the server 102 looks up a default time-temperature pair in the cooking services database 104. In accordance with the step 204, the server 102 employs the food type and food quantity parameters to look up the default time-temperature correlated to the food type and food quantity parameters in the cooking services database 104.

At a step 206, the server 102 determines whether the default time-temperature pair is suitable for yielding a cooked food meeting the food type, food quantity, cook begin time and cook finish time parameters.

If, at the step 206, it is determined that the default time-temperature pair is suitable, a step 208 is performed. Otherwise, if it is determined that the default time-temperature pair is not suitable, a step 210 is performed.

At the step 208, the server 102 derives a cooking control routine from the default time-temperature pair. In one example, the method includes an additional step at which the server 102 provides the default time-temperature pair to a client interface.

At the step 210, the server 102 produces a new time-temperature pair. In accordance with the step 210, the server 102 optionally adjusts the default time-temperature pair in accordance with the food quantity parameter and/or the cooking device parameters.

Moreover, the step 210 may include a sub-step at which the server 102 applies the adaptation rule from the cooking services database 104.

Next, at a step 212, the server 102 assesses whether the new time-temperature pair represents an unacceptable deviation from one or more time-temperature pairs known to yield a palatable and safely cooked food.

If, at the step 212, it is assessed that the new time-temperature pair represents an acceptable deviation, a step 214 is performed.

If it is assessed that the new time-temperature pair represents an unacceptable deviation, the step 210 is performed again. As a result, the steps 210 and 212 are executed iteratively.

If the iterative execution of the steps 210 and 212 fails to establish an acceptable new time-temperature pair, the iterative execution may be concluded after a number of iterations equal to a predetermined limit number. In one example, the method may include an additional step at which the server 102 provides a notification to the client interface reflecting a failure to establish an acceptable new time-temperature pair.

At the step 214, the server 102 derives the cooking control routine from the new time-temperature pair. In one example, the method may include an additional step at which the server 102 provides the new time-temperature pair to the client interface.

At a step 216, the server 102 transmits the cooking control routine to the cooking control module 112 of the cooking device 108.

At a step 218, the cooking device 108 performs a cooking process in accordance with the cooking control routine.

At a step 220, the server 102 receives cooking feedback from the client interface.

In an example, the method may include an additional step at which the server 102 modifies the default time-temperature pair in accordance with the cook feedback, and updates in the cooking services database 104. Alternatively, the method may include an additional step at which the server 102 stores the new time-temperature pair as another default time-temperature pair separately in the cooking services database 104.

The steps 202 to 220 are only illustrative and other alternatives can also be provided where one or more steps are added, one or more steps are removed, or one or more steps are provided in a different sequence without departing from the scope of the claims herein.

Embodiments of the present disclosure provide a program product recorded on non-transient machine-readable data storage media, wherein the program product is executable upon computing hardware for implementing the method as described in conjunction with FIGS. 2A-C on the cooking system 100.

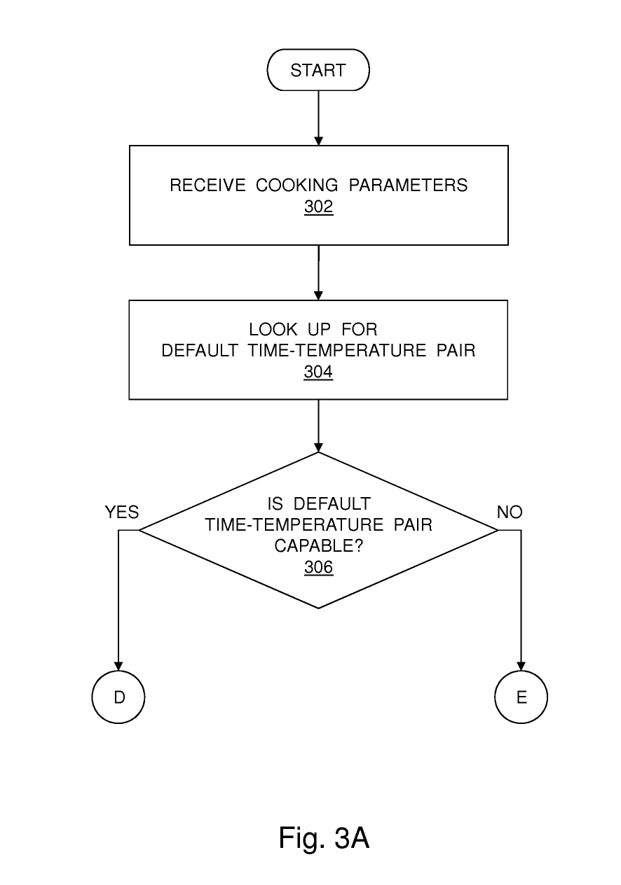

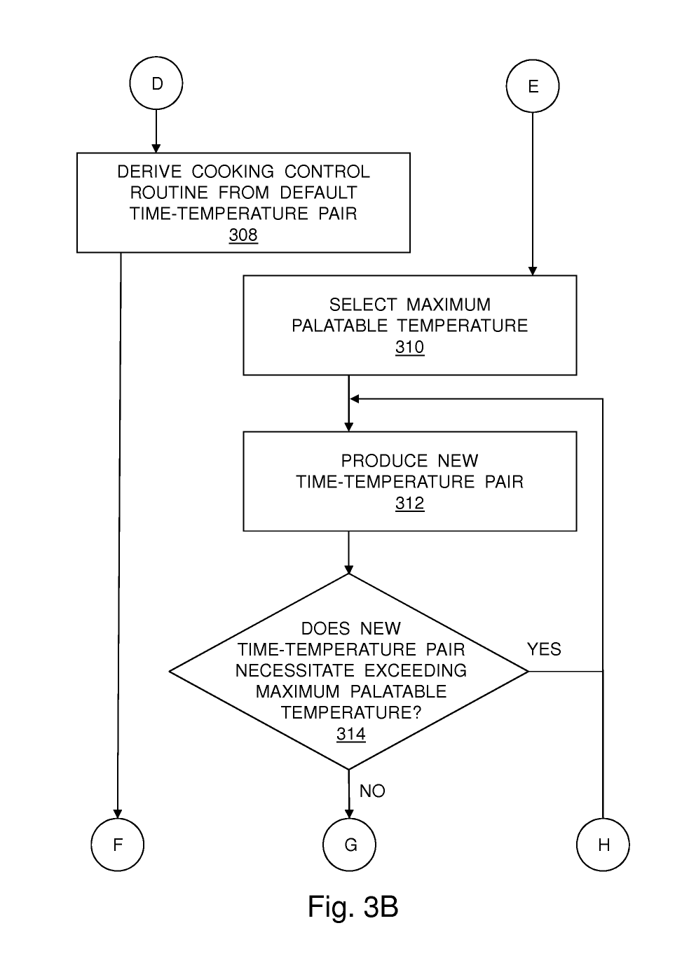

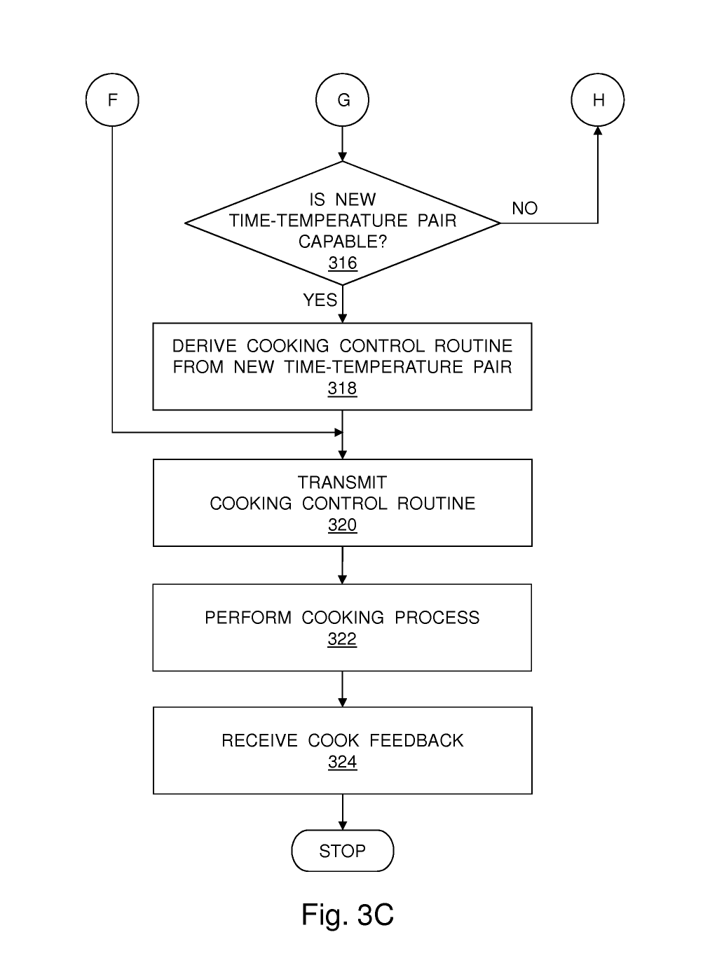

FIGS. 3A, 3B and 3C collectively illustrate steps of a method for food treatment, in accordance with an embodiment of the present disclosure. The method is depicted as a collection of steps in a logical flow diagram, which represents a sequence of steps that can be implemented in hardware, software, or a combination thereof.

By way of example only, the method has been illustrated with reference to the cooking system 100 as described in conjunction with FIG. 1.

At a step 302, the server 102 receives various cooking parameters including one or more of: food type, food quantity, degree of cook, cook begin time, and cook finish time parameters. In accordance with the step 302, the server 102 may receive one or more of the various cooking parameters from the remote client interface of the user device 106.

At a step 304, the server 102 employs the food type and food quantity parameters to look up a default time-temperature correlated to the food type and food quantity parameters in the cooking services database 104.

At a step 306, the server 102 determines whether the default time-temperature pair is capable of yielding a cooked food meeting the food type, food quantity, cook begin time and cook finish time parameters.

If, at the step 306, it is determined that the default time-temperature pair is capable of yielding a cooked food complying with the received parameters, a step 308 is performed. Otherwise, if it is determined that the default time-temperature pair is incapable, a step 310 is performed.

At the step 308, the server 102 derives a cooking control routine from the default time-temperature pair.

At a step 310, the server 102 employs the food type and food quantity parameters to select a maximum palatable temperature from the cooking services database 104.

At the step 312, the server 102 produces a new time-temperature pair. In accordance with the step 312, the server 102 may adjust the default time-temperature pair in accordance with the food quantity parameter and/or the cooking device parameters.

Moreover, the step 312 may include a sub-step at which the server 102 applies the adaptation rule from the cooking services database 104.

At a step 314, the server 102 determines whether the new time-temperature pair necessitates exceeding the maximum palatable temperature.

If, at the step 314, it is determined that the new time-temperature pair necessitates exceeding the maximum palatable temperature, the step 312 is repeated.

Otherwise, if it is determined that the new time-temperature pair does not necessitate exceeding the maximum palatable temperature, a step 316 is performed.

At the step 316, the server 102 determines whether the new time-temperature pair is capable of yielding a cooked food meeting the degree of cook parameter.

If, at the step 316, it is determined that the new time-temperature pair is not capable of yielding a cooked food meeting the degree of cook parameter, the step 312 is repeated.

Otherwise, if it is determined that the new time-temperature pair is capable of yielding a cooked food meeting the degree of cook parameter, the step 318 is performed.

At the step 318, the server 102 derives the cooking control routine from the new time-temperature pair.

At a step 320, the server 102 transmits the cooking control routine to the cooking control module 112 of the cooking device 108.

At a step 322, the cooking device 108 performs a cooking process in accordance with the cooking control routine.

At a step 324, the server 102 receives cooking feedback from the client interface.

In an example, the method may include an additional step at which the server 102 modifies the default time-temperature pair in accordance with cooking feedback, and updates in the cooking services database 104. Alternatively, the method may include an additional step at which the server 102 stores the new time-temperature pair as another default time-temperature pair separately in the cooking services database 104.

The steps 302 to 324 are only illustrative and other alternatives can also be provided where one or more steps are added, one or more steps are removed, or one or more steps are provided in a different sequence without departing from the scope of the claims herein.

Embodiments of the present disclosure provide a program product recorded on non-transient machine-readable data storage media, wherein the program product is executable upon computing hardware for implementing the method as described in conjunction with FIGS. 3A-C on the cooking system 100.

Embodiments of the present disclosure are susceptible to being used for various purposes, including, though not limited to, facilitating personalization of a time-temperature pair for easy and safe “sous-vide” cooking of food.

Modifications to embodiments of the present disclosure described in the foregoing are possible without departing from the scope of the present disclosure as defined by the accompanying claims. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

1. A method for “sous-vide” cooking, comprising:
receiving food type, food quantity, cook begin time, and cook finish time parameters;
looking up a default time-temperature pair in a cooking services database;
when the default time-temperature pair is suitable for yielding a cooked food meeting the food type, food quantity, cook begin time, and cook finish time parameters, deriving a cooking control routine from the default time-temperature pair; and
performing a cooking process in accordance with the cooking control routine.

2. The method as set forth in claim 1, further comprising providing the default time-temperature pair to a client interface.

3. The method as set forth in claim 1, further comprising transmitting the cooking control routine to a cooking control module arranged to regulate conditions of a cooking chamber.

4. The method as set forth in claim 1, further comprising adjusting the default time-temperature pair in accordance with the food quantity parameter, wherein the food quantity parameter is measured by a scale of a cooking device.

5. The method as set forth in claim 1, further comprising:
producing a new time-temperature pair when the default time-temperature pair is not suitable; and
assessing whether the new time-temperature pair represents an unacceptable deviation from one or more time-temperature pairs known to yield a safely cooked food.

6. The method as set forth in claim 5, further comprising iteratively executing the producing and assessing actions while the new time-temperature pair represents an unacceptable deviation from the one or more time-temperature pairs known to yield a and safely cooked food.

7. The method as set forth in claim 6, further comprising concluding the iterative executing after a number of iterations equal to a predetermined limit number.

8. The method as set forth in claim 6, further comprising, after a number of iterations equal to a predetermined limit number, providing a notification to a client interface reflecting a failure to establish an acceptable new time-temperature pair.

9. A method for food treatment, comprising:
receiving input from a client interface regarding food type, food quantity, degree of cook, cook begin time, and cook finish time parameters;
employing the food type and food quantity parameters to look up, in a cooking services database, a default time-temperature pair correlated to the food type and food quantity parameters;
producing a new time-temperature pair when the default time-temperature pair is not capable of yielding a cooked food meeting the food type, food quantity, cook begin time and cook finish time parameters;
deriving a cooking control routine from the new time-temperature pair;
transmitting the cooking control routine to a cooking control module of a cooking device; and
with the cooking control module, performing a cooking process and activating a cooling module of the cooking device in accordance with the cooking control routine.

10. The method as set forth in claim 9, further comprising:
employing the food type and food quantity parameters to select a maximum palatable temperature from the cooking services database;
determining whether the new time-temperature pair necessitates exceeding the maximum palatable temperature; and
repeating the producing action when the new time-temperature pair necessitates exceeding the maximum palatable temperature.

11. The method as set forth in claim 9, further comprising repeating the producing action when the new time-temperature pair is not capable of yielding a cooked food meeting the degree of cook parameter.

12. The method as set forth in claim 9, further comprising adjusting the default time-temperature pair in accordance with parameters of the cooking device.

13. The method as set forth in claim 9, wherein producing the new time-temperature pair further comprises applying an adaptation rule from the cooking services database.

14. The method as set forth in claim 13, wherein the adaptation rule is influenced by a heat equation approximation for the food type and food quantity parameters.

15. The method as set forth in claim 13, wherein the adaptation rule is influenced by pathogen decay curves.

16. The method as set forth in claim 9, further comprising:
receiving cooking feedback from the client interface; and
modifying the default time-temperature pair in accordance with the cooking feedback.

17. The method as set forth in claim 9, further comprising providing the new time-temperature pair to a client interface.

18. (canceled)

19. The method as set forth in claim 9, further comprising, with the cooking control module, activating a heating module of the cooking device in accordance with the cooking control routine.

20. The method as set forth in claim 9, further comprising, in accordance with the cooking control routine, employing the cooking control module to control agitation and/or circulation of a cooking medium held by a cooking chamber of the cooking device in accordance with the cooking control routine.

21. A method for “sous-vide” cooking with a cooking device, comprising:
receiving, from a client interface remote from the cooking device, food type, food quantity, cook begin time, and cook finish time parameters;
looking up a default time-temperature pair in a cooking services database;
producing a new time-temperature pair when the default time-temperature pair is not suitable;
assessing whether the new time-temperature pair represents an unacceptable deviation from one or more time-temperature pairs known to yield a safely cooked food;
iteratively executing the producing and assessing actions while the new time-temperature pair represents an unacceptable deviation from the one or more time-temperature pairs known to yield a safely cooked food; and
when the default time-temperature pair is suitable for yielding a cooked food meeting the food type, food quantity, cook begin time, and cook finish time parameters, deriving a cooking control routine from the default time-temperature pair and performing a cooking process in accordance with the cooking control routine.
